(19) United States
(12) Patent Application Publication
(10) Pub. No.: US 2003/0041166 A1
(43) Pub. Date: Feb. 27, 2003

(54) Method for transmitting data over a physical medium

(76) Inventor: Richard Williamson, Faringdon (GB)

Correspondence Address: Davidson, Davidson & Kappel, LLC, 485 Seventh Avenue, New York, NY, 10018, US

(21) Appl. No.: 09/933,369

(22) Filed: Aug. 20, 2001

(51) Int. Cl. G06F 15/16; G06F 9/46; G06F 9/44

(52) U.S. Cl. 709/236; 709/313; 709/250; 717/124

(57) ABSTRACT

A method is provided for transmitting a data entity. A first data entity is intercepted from a stream of processing, before the stream of processing sends the data over a first medium. The first medium is different from a second medium. One or more data elements are added to the first data entity to generate a second data entity. The data elements allow the second data entity to be transferred over the second medium. The second data entity is then transmitted over the second medium. The data elements are removed from the second data entity to generate the first data entity. The first data entity is inserted into the stream of processing, after the stream of processing would have sent the data entity over the first medium

### BACKGROUND INFORMATION

A computer program can be viewed as a detailed plan or procedure for solving a problem with a computer: an ordered sequence of computational instructions necessary to achieve such a solution. The distinction between computer programs and equipment is often made by referring to the former as software and the latter as hardware. In order to simplify the logic of writing a program, computer programs make use of different programming objects, such as a mailbox. A mailbox is a destination for interprocess messages in a message passing system. The mailbox can be understood as a message queue, usually stored in the memory of the processor on which the receiving process is running. Generally, primitives are provided in a software system for sending a message to a named mailbox and for reading messages from a mailbox. A wrapper, another type of programming object, is code which is combined with another piece of code to determine how that first code is executed. The wrapper acts as an interface between its caller and the wrapped code. This may be done for compatibility (e.g., if the wrapped code is in a different programming language or uses different calling conventions), or for security, (e.g., to prevent the calling program from executing certain functions).

Computers can be organized into a network, for example, a client-server network. In a client-server network, the client (or clients) and a server (or servers) exchange data with one-another over a physical network. An agent is the part of the client-server network that performs information preparation and exchange on behalf of a client or server. Different protocols have been designed to facilitate the exchange of data over the computer network.

Connection-oriented protocols require a channel to be established between the sender and receiver before any messages are transmitted. Examples of connection-oriented protocols include TCP/IP (Transmission control protocol/Internet Protocol). TCP/IP encompasses both network layer and transport layer protocols.

In contrast, connectionless protocols refer to network protocols in which a host can send a message without establishing a connection with the recipient. That is, the host simply puts the message onto the network with the destination address and hopes that it arrives. Examples of connectionless protocols include Ethernet, IPX, and UDP. In other words, the connectionless protocol is a data communication method in which communication occurs between hosts with no previous setup. Packets sent between two hosts may take different routes. It is also known as packet switching.

UDP (User Datagram Protocol) uses the Internet standard network layer, transport layer, and session layer protocols to provide simple datagram services. UDP is a connectionless protocol which, like TCP, is layered on top of IP. UDP neither guarantees delivery nor does it require a connection. In this regard, error processing and retransmission is taken care of by the application program rather than the UDP protocol. However, UDP may add a checksum and additional process-to-process addressing information to the datagram.

Remote Procedure Call (RPC) is a protocol that allows a program running on one host to cause code to be executed on another host without the programmer needing to explicitly code for this. RPC is a common paradigm for implementing the client-server model of distributed computing. An RPC is initiated by the caller (client) sending a request message to a remote system (the server) to execute a certain procedure using arguments supplied. A result message is returned to the caller. There are many variations and subtleties in various implementations, resulting in a variety of different (and often incompatible) RPC protocols.

Sun Microsystem's RPC protocol uses external data representation (XDR) as a standard for encryption and encoding of data. In order to be transmitted correctly, data is formatted using a language that describes data formats. For example, an integer value being transmitted would be formatted as an XDR signed integer. This allows a data value transmitted to remain as the same value on the receiving device, irrespective of the architectures involved at either end of the transmission. For example, on one architecture, the value 00000010 (in binary) might be used to represent the value ‘2’ (in decimal) internally. However, a second architecture might use 00100000 to represent ‘2’ and the value 00000010 might represent 32. XDR allows a device using the first scheme to send an arbitrary value to a device using the second scheme, or vice versa, and be assured that the value received will be equivalent in absolute terms to the value sent. In cases where the data can not be formatted using XDR's language, errors may arise in the transmission of data. Moreover, a custom back end has to be written for programs that do not use XDR and this results in increased development costs.

In any event, in order for computers to communicate with each other on a network, the computers must use a common communications protocol.

### SUMMARY

In accordance with a first embodiment of the present invention, a method is provided for transmitting a data entity. A first data entity is intercepted from a stream of processing, before the stream of processing sends the data over a first medium. The first medium is different from a second medium. One or more data elements are added to the first data entity to generate a second data entity. The data elements allow the second data entity to be transferred over the second medium. The second data entity is then transmitted over the second medium. The data elements are removed from the second data entity to generate the first data entity. The first data entity is inserted into the stream of processing, after the stream of processing would have sent the first data entity over the first medium.

In accordance with a second embodiment of the present invention, a method is provided for transmitting a plurality of data entities. A first of one of the data entities is intercepted from a stream of processing, before the stream of processing sends the data entity over a first medium. The first medium is different from a second medium. One or more data elements are added to the first data entity to generate a second data entity. The data elements allow the first data element to be transferred over the second medium. The second data entity is transmitted over the second medium. The data elements are removed to generate the first data entity. The first data entity is inserted into the stream of processing, after the stream of processing would have sent the first data entity over the first medium. For each remaining data entity, the steps of intercepting, adding, transmitting, removing, and inserting are repeated.

In accordance with a third embodiment of the present invention, a method for receiving a data entity is provided. A first data entity that is transmitted over a second medium is received. The second medium is different from a first medium, and the first data entity has been transformed from a second data entity by the addition of one or more data elements. The second data entity is generated by removing the data elements. The second data entity is inserted into a stream of processing.

In accordance with a fourth embodiment of the present invention, a method is provided for transmitting a data entity. A data entity is intercepted from a stream of processing, before the stream of processing sends the data entity over a first medium, the first medium differing from a second medium. One or more data elements are added to format the data entity for the second medium. The data entity is sent over the second medium.

In accordance with a fifth embodiment of the present invention, a method for transmitting a plurality of data entities in parallel is provided. A plurality of threads are generated. Each thread is executable on a separate processing device and each thread can intercept a first data entity from a stream of processing, before the stream of processing sends the data over a first medium. The first medium is different from a second medium. Each thread can also add one or more data elements to the first data entity to generate a second data entity, the data elements allowing the second data entity to be transferred over the second medium; transmit the second data entity over the second medium; remove the data elements from the second data entity to generate the first data entity; and insert the first data entity into the stream of processing, after the stream of processing would have sent the first data entity over the first medium.

### BRIEF DESCRIPTION OF THE DRAWINGS

FIG. 1 shows a first software tool on a first host, and a second software tool on a second host.

FIG. 2 shows a method by which the first and second software tools communicate with one another when an expected physical medium does not exist or is inoperative.

FIG. 3 illustrates an exemplary application of an embodiment of the present invention showing a host and target system architecture.

FIG. 4 shows a method by which a packet driver on an agent configures itself.

FIG. 5 shows a method by which server that transmits the packet to a mailbox space.

FIG. 6 shows a method by which an agent retrieves the packet sent by server from the mailbox space.

FIG. 7 shows a method by which an agent writes to the mailbox space.

FIG. 8 shows a method by which server retrieves the packets from the mailbox space.

### DETAILED DESCRIPTION OF THE PREFERRED EMBODIMENTS

In accordance with a preferred embodiment of the present invention, data formatted for an expected physical transmission medium is transmitted to a destination over an unrelated physical transmission medium. In this regard, data is extracted from a normal processing method on a first device after the data has been formatted for the expected physical transmission medium. The normal processing method is designed to send the data over the expected physical medium to a second device. After extraction, a program is used to insert the data into a wrapper for the unrelated physical medium. The program then sends the data with the wrapper over the unrelated physical medium to the second device. On the second device, the wrapper is removed by another program, so that the data is now formatted for the expected physical transmission medium. The data is then re-inserted into a normal processing method on the second device. Thus, from the perspective of applications running on the first and second device, the data has been sent via the expected physical transmission medium. The data received remains semantically equivalent to the data sent. For example, if a float value of 3.1415 is sent, a float value of 3.1415 is received. Moreover, the data is encoded irrespective of the data's use (e.g., the present invention would perform the same steps on an integer and a string of the same byte length). Thus, no special language is required to represent particular data types.

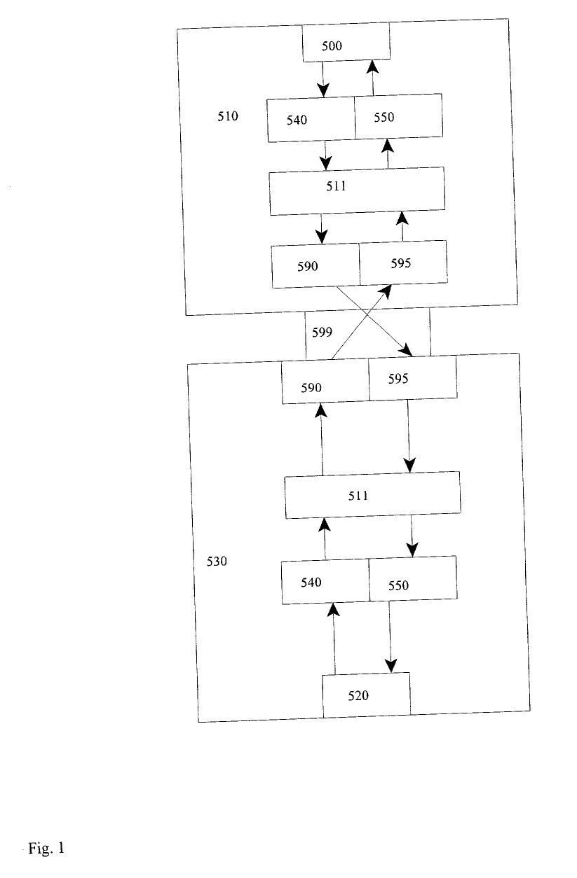

FIG. 1 shows a first software tool 500 on a first host 510, and a second software tool 520 on a second host 530. In certain embodiments, the first software tool 500 can be a debugger and the second software tool 520 can be an application that is being debugged. The first software tool 500 transmits data to the second software tool 520 running on the second host 530. Likewise, the second software tool 520 transmits data to the first software tool 500 running on the first host 510.

A source tool 540 and a destination tool 550 are on both the first host 510 and the second host 530. The source tool 540 starts the transmission of outgoing data and the destination tool 550 receives incoming data.

A physical connection 599 is used to transmit the data. However, in FIG. 1 the physical connection 599 is not the type of physical connection expected by the source tool 540 and the destination tool 550. For example, the source tool 540 and the destination tool 550 may expect to communicate over a packet switching network, but the physical connection 599 is a direct hardware connection (e.g., a parallel port).

A software program 590 is implemented on the first and second host 510,530. A destination agent 595 is also implemented on the first and second host 510,530. The software program 590 and the destination agent 595 work in conjunction to mimic the expected physical medium and capture any data that is sent to the physical medium 599. In certain embodiments, the software program 590 and destination agent 595 capture any data that is sent ‘through’ a network (e.g., a LAN). For example, the data can be information coming from an alternate host via the actual physical medium (e.g., the first and second host 510,530 are nodes on a the LAN). In other embodiments, the destination agent 595 is not present, and the functions of the destination agent 595 are implemented by the software program 590.

An expected medium interface 511 is present on both the first and second host 510,530. The expected medium interface 511 reads any incoming data over the expected physical medium and formats the data for the destination tool 550. For example, the expected medium interface 511 may reassemble data packets received over a packet switching network. The expected medium interface 511 may also perform error checking and/or assemble incoming packets. The expected physical medium interface 511 may also intercept outgoing data, and hand the data off to the software program 590.

In an embodiment where the physical medium expected by the sending host and the actual physical medium 599 are the same, the software program 590 can be omitted from the sending host. Moreover, in an embodiment where the physical medium expected by the receiving host and the actual physical medium 599 are the same, the destination agent 595 can be omitted from the receiving host.

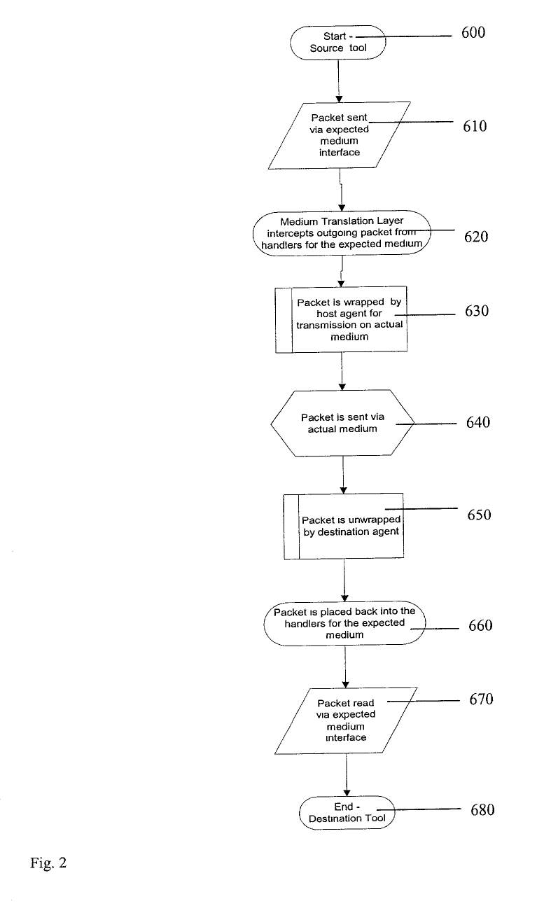

FIG. 2 shows a method by which the first and second software tools 500,520 communicate with one another when an expected physical medium does not exist or is inoperative. For example, if a connection on a packet switching network is inoperative or not present, the method can allow communication over a parallel port.

The method starts with the source tool 540 receiving data to transmit from one of the software tools 500,520 (Step 600).

Next, the data is passed to the expected medium interface 511 (Step 610). In step 610, the data is formatted for the expected medium of communication. For example, the data can be formatted as one or more UDP packets for a packet switching network.

Then a medium translation layer, which can be implemented by the software program 590, intercepts the data (e.g., the packets) from the normal processing method for the expected medium (Step 620). For example, the packets can be removed from handlers for such packets.

Once the data is captured, a host agent, which can be implemented by the software program 590, wraps the data with additional information that will allow the data to be transmitted over the actual physical medium (Step 630). For example, the software program 590 may add extra bits to the original data or a portion of the original data, and thus form a UTDP packet. Moreover, the data can also be altered so that the data conforms to a fixed packet length as the actual medium requires, or to a no protocol-defined method of indicating the end of one packet and the beginning of another (e.g., a byte stream). For example, a UDP packet can be wrapped by the software program to conform to connections using JTAG or in-circuit emulation (ICE) connections. In certain embodiments, the host agent may also add additional data to the wrapper to aid the destination host in recreating the original data or to detect errors. For example, the host agent may add hamming code bits to the data. In certain embodiments where the actual transmission medium is not trustworthy, encryption techniques can be used on the original data packet.

The data or a portion thereof (e.g., one or more packets) is then sent via the actual medium (Step 640). For example, the data can be sent over a parallel port.

Once the data or a portion thereof has been transmitted, the destination agent 595 captures the data and unwraps the data (Step 650). In certain embodiments, the destination agent 595 reads the additional data in the wrapper information to recreate the original packet and/or check for errors. In certain embodiments, the functionality of the destination agent 595 can instead be implemented by the software program 590.

The recreated data is then reinserted into the normal processing method (Step 660). For example, packets can be placed back into the handlers for such packets. The expected medium interface 511 then reads and formats the data (Step 670). For example, the data can be read and/or assembled from the original UDP packets.

The data is then passed to the destination tool 550 (Step 680). The destination tool 550 then forwards the data to the receiving software tool 500, 520. For example, if the first software tool 500 sends the data, then the second software tool 520 receives the data, and vice versa.

In an embodiment where the actual physical medium and the expected physical medium for the destination are the same, the above method can be applied without Steps 650 and 660. The destination agent 595 is not necessary in such an embodiment. Furthermore, in an embodiment where the actual physical medium and the expected physical medium for the source are the same, Steps 620 and 630 can be omitted. In embodiments where the sending software tool 500,520 can communicate directly with the expected medium interface 511, the source tool 540 can be omitted. Moreover, in other embodiments where the receiving software tool 500,520 can communicate directly with the expected medium interface 511, the destination tool 550 can be omitted.

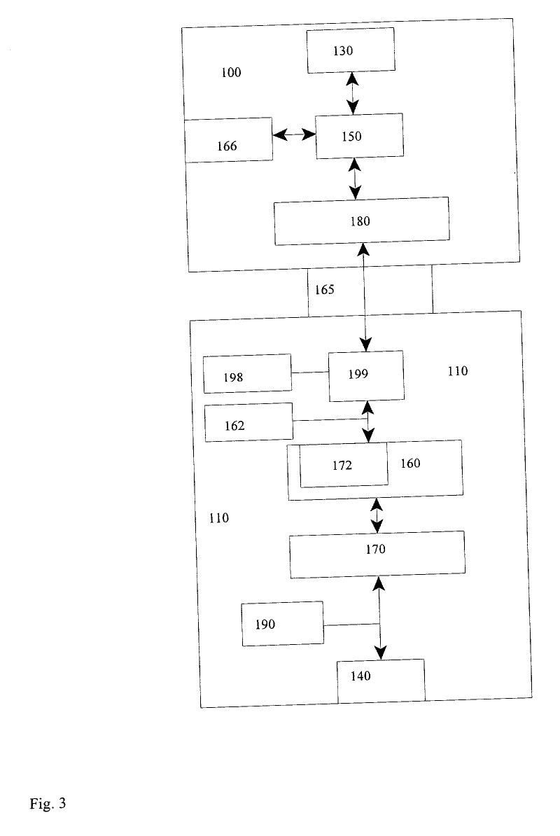

FIG. 3 illustrates an exemplary application of an embodiment of the present invention showing a host 100 and target 110 system architecture. In FIG. 3, host 100 can be executing the Tornado® IDE and the target 110 can be executing a VxWorks® operating system 190, both distributed by Wind River Systems. In FIG. 3, unlike FIG. 1, the target 110 is expecting data formatted for an indirect connection 165. The host 100 is expecting data formatted for a medium other than the indirect connection 165. Thus, the data destined for the target 110 is formatted for the indirect connection 165 by software (described below) executing on the host 100. Moreover, the software tools also format incoming data from the target 110 for the medium expected by the host 100. It will be appreciated, however, that FIG. 3 is merely an example, and the embodiments of the present invention can be implemented in any suitable enviroument.

The target 110 is a system development board. The system development board can be, or use, an ARC core (an extensible 32-bit RISC core that allows an ASIC designer to configure and extend the capabilities of the processor). The system development board lacks the actual physical parts for a direct connection between the host 100 and the target 110 (e.g., no ethernet transceiver or no serial transceiver, as expected by the Tornado® VxWorks® environment). However, the development board supports an indirect connection 165 between the host 100 and the target 110. The indirect connection 165 for the target 110 (the system development board) is through a bidirectional parallel port. A host-side driver code, in the form of a dynamic link-library (DLL) 166 supports reading/writing target memory. In certain embodiments, the DLL 166 can be an ARC target debug interface DLL (a DLL used for controlling the ARC processor).

The indirect connection 165 on the target 110 (the development board) is driven by an external (on-board, off-CPU) control/debugging device 170. The control/debugging device 170 can read/write memory, read/write processor internal registers, and start/stop the processor on the target 110. The DLL library 166 supplied by the vendor, which manufactures the hardware, allows use of the indirect connection 165 for control of the control/debugging device 170.

A debugger 130 is present on the host 100. The debugger 130 is used to debug an application 140 on the target 110 (or the target 110 itself). In order to perform the debugging, the debugger 130 and the target 110 need to communicate with one-another. In so doing, the debugger 130 communicates with a target server 150, which runs on the host 100. In certain embodiments, the communication between server 150 and the debugger 130 can be via the Wind River Systems' WDB_RPC (Wind DeBug Remote Procedure Call protocol) or WTX (Wind Tool eXchange protocol). WDB_RPC is a two part protocol (e.g., host-to-target-to-host) that allows host tools or a target server to make a call on or manipulate the target. WTX is a single part protocol (e.g., tool-to-target server) that is used for host-to-host or inter-tool communication. WTX is the protocol that the target server and Tornado® Tools, such as WindSh, CrossWind, or WindView, use to communicate and exchange data.

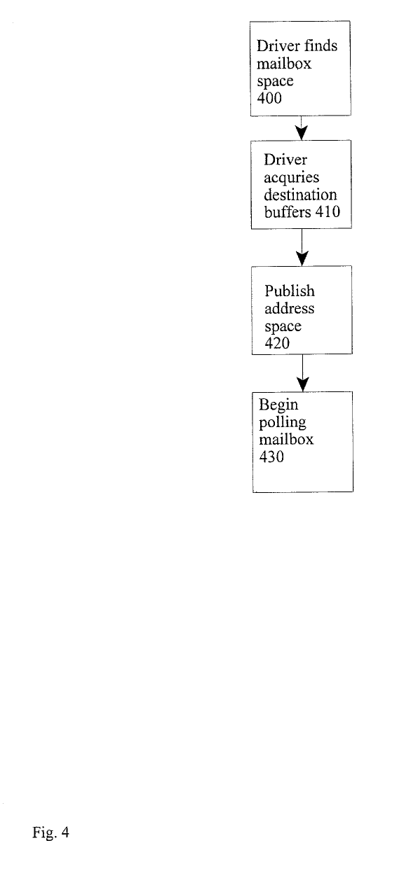

Server 150 relays the data to a target agent 160, which is running on the target 110. Agent 160 then communicates with the facilities of target 110 (e.g., operating system 190) or the application 140 running on the target 110. Both server 150 and agent 160 are configured for transmission of UDP packets over a standard ethernet connection. In certain embodiments, both server 150 and agent 160 can be configured for transmission of data using the JTAG, ICE, and USB protocols. In order to facilitate communication between agent 160 and server 150, agent 160 has a packet driver 172, which configures itself when the target 110 boots up (See FIG. 4). The packet driver 172 can be, for example, Wind River Systems' ‘Direct to Memory’ (wdbDtmPktDrv.c) packet driver. The packet driver 172 is used to handle (e.g., read, error-check, and assemble) incoming packets. In embodiments using JTAG, ICE, or USB protocols, the packet driver 172 can be configured to accept data from a JTAG, ICE, or USB back end. In embodiments using the USB protocol, instead of using a mailbox/polling method (shown below in FIGS. 4-8), a packet driver (e.g., wdbUsbPktDrv) can be plugged directly into agent 160.

The WTX and WDB_RPC protocols can work in conjunction with one another. For example, the debugger 130 can send a WTX packet to sever 150. Server 150 then formats and sends a WDB_RPC call (e.g., as a packet), which will cause the target 110 to execute certain code. The return value and data are returned to server 150 by the return half of the WDB_RPC call (e.g., a packet). Server 150 can then format a second WTX packet and send it to the debugger 130.

The communication between server 150 and agent 160 is by the WDB_RPC protocol, which allows communication over a direct connection. The WDB_RPC protocol is the Wind River Systems implementation of the RPC protocol, which implements data exchange over one of several available physical connections. However, in FIG. 3, the physical connection available on the target is the indirect connection 165, which does not support the WDB_RPC protocol.

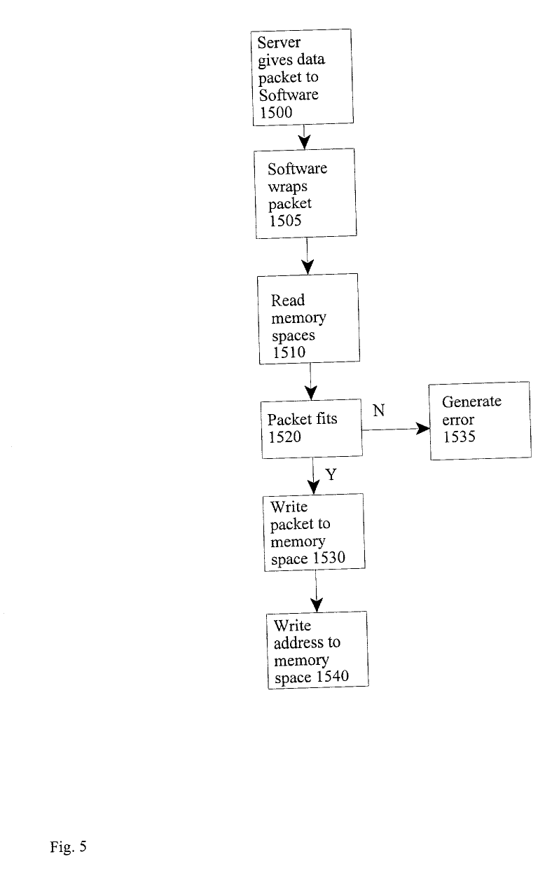

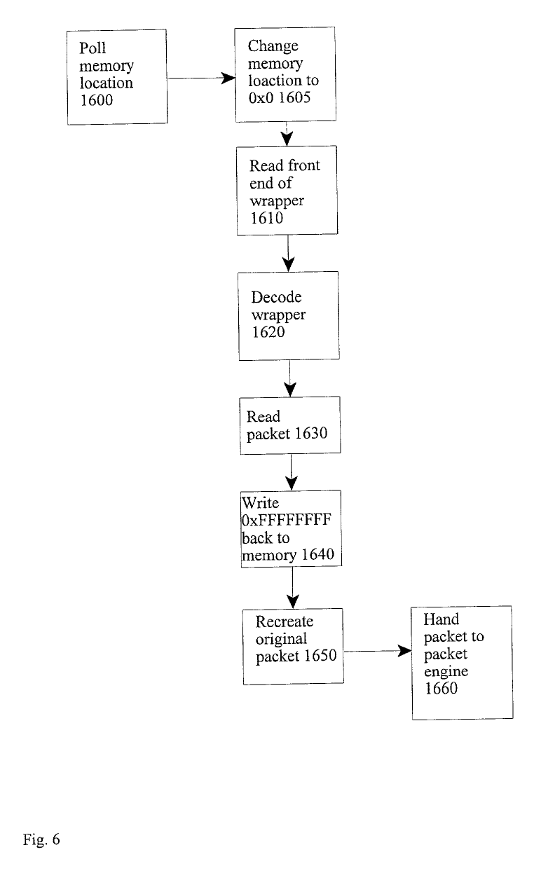

In order to facilitate communication between server 150 and agent 160, a software entity 180, which is resident on the host 100, wraps the WDB_RPC formatted data transmitted from server 150 to agent 160 (See FIG. 5). The data is wrapped so that the data can be sent over the indirect connection 165. After transmission across the indirect connection 165, agent 160 decodes the data and hands the data for execution (See FIG. 6).

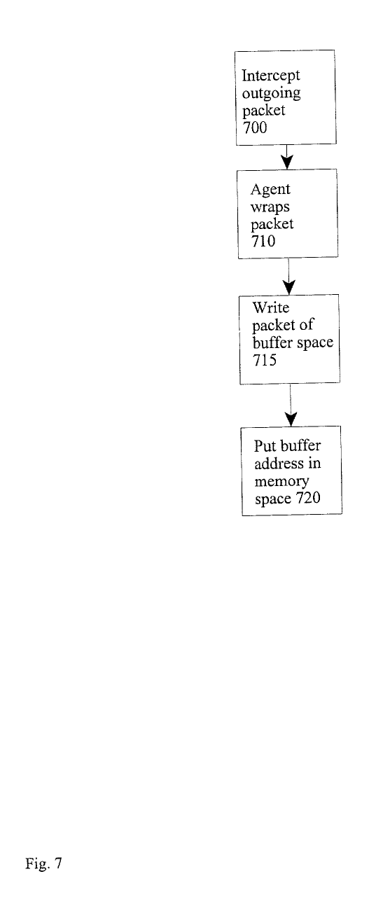

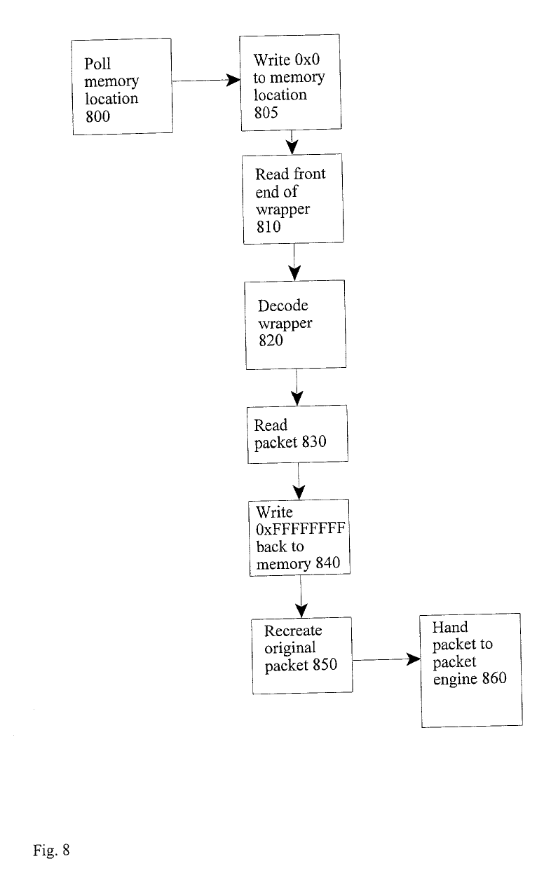

When agent 160 transmits to server 150, agent 160 can wrap the data so that the data can be pulled over the indirect connection 165 by use of the DLL library 166 (See FIG. 7). In certain embodiments, the wrapping functionality can be implemented as a plug-in to the agent 160. In still further embodiments, the packet driver 172 can perform the wrapping. In embodiments wherein the target is not expecting to communicate via the indirect connection (as in FIG. 1), a second software entity 162 can perform the wrapping. In any event, after transmission across the indirect connection 165, software entity 180 decodes the data and hands off the UDP packets for execution (See FIG. 8).

Software entity 180 is transparent to server 150. Thus, server 150 sees the connection as server 150 to agent 160, instead of server 150 to software entity 180 to agent 160.

Software entity 180 and agent 160 use a mailbox space 199 to communicate. The mailbox space 199 is located on the target 110, however, in certain embodiments, the mailbox space 199 can be located on the host 100. The mailbox space 199 can be configured as 8×32 bit words.

Table 1 shows an exemplary memory layout within the mailbox space 199.

TABLE 1

| | |
|---|---|
| wdbDtmPktDrvUp | +0x00 = Target to Host Handshake Mailbox |
| | (TTH_HS) (for agent to server communication) |
| | +0x04 = “ImOk” validates data in mailbox space |
| | 199 (IMOK) (for checking validity) |
| | +0x08 = IRQ to use (IRQ) (for checking if the |
| | debug control device can cause an interrupt on the |
| | CPU) |
| | +0x0c = counter of packets sent (HIT COUNT) (for |
| | agent to server communication to aid debugging) |
| | +0x10 = Host to Target Handshake Mailbox |
| | (HTT_HS) (for server to agent communication) |
| | +0x14 = Host to Target (BFRLOC) (a download |
| | buffer address for server to agent communication) |
| | +0x18 = Host to Target (BFRSIZ) (a download |
| | buffer size for server to agent communication) |
| | +0x0c = counter of packets sent (HIT COUNT) (for |
| | server to agent communication for debug purposes) |

The wdbDtmPktDrvUp referred to in Table 1 is a label used to define an arbitrary starting point (which the host is aware of) in memory. In the HHT_HS and TTH_HS register, a 0x0 value is a ‘BUSY’ state, a 0xffffff value is an ‘EMPTY’ state, and any other value is the address of the packet to be read. The state change from BUSY to EMPTY occurs once the packet has been successfully read (e.g., a local copy is made.) Once the packet has been successfully read, EMPTY is written to either HHT_HS or TTH_HS, depending on which one had the address of the packet.

Table 2 shows an exemplary layout of the mailbox space 199 in memory.

TABLE 2

0x - - - 00 <TTH_HS><IMOK> <IRQ?> <HIT COUNT>
0x - - - 10 <HTT_HS><BFRLOC><BFRSIZ><HIT COUNT>

In certain embodiments, software entity 180 can be located on both the host 100 and target 110. Moreover, software entity 180 can incorporate the wrapping and decoding functionality of agent 160. For example, software entity 180 can wrap the UDP packets originating from agent 160 and decode the packets arriving over the indirect connection 165. In such an embodiment, software entity 180 is transparent to both server 150 and agent 160.

Software entity 180 and agent 160 also use a buffer 198 to transmit data. The buffer 198 is preferably located on the target 110. However, in certain embodiments, the buffer 198 can be located on the host 100. Preferably, the buffer 198 is allocated from available memory of the target 110. Most preferably, the buffer 198 allocation is dynamic.

FIGS. 4-8 illustrate methods by which server 150 and agent 160 communicate with one-another using the architecture of FIG. 3. It will be appreciated, however, that FIGS. 4-8 serve merely as examples, and the embodiments of the present invention can be implemented in any suitable manner.

FIG. 4 shows the method by which the packet driver 172 on agent 160 configures itself. When the target 110 boots, the packet driver 172 finds its mailbox space 199 (Step 400). In order to avoid overwriting meaningful data, the mailbox space 199 can be configured during the build of the target 110. This will prevent the server 150 from overwriting valuable data.

The packet driver 172 then acquires a receiving destination buffer (e.g., reserves a portion of the buffer 198) for receiving packets and a transmit destination buffer for sending packets (Step 410). For example, destination buffers for data arriving from server 150 (via software entity 180) and for data destined for server 150 are acquired.

The addresses of the destination buffers are then published for the packet in the mailbox space 199 (Step 420). Preferably, the destination buffers are dynamically allocated. When packet driver 172 sends data, agent 160 writes the location of the buffer of the data being sent into TTH_HS. However, in other embodiments, packet driver 172 can use any available memory space as the buffer of the data.

Agent 160 then begins polling on one of the mailbox locations (Step 430). For example, agent 160 checks the status of HTT_HS to see if a value other than 0xffffffff is present.

FIG. 5 shows the method by which server 150 transmits a packet to the mailbox space 199.

The software entity 180 receives the data packet from a host resident program using server 150 (e.g., the debugger 130) for transmission. (Step 1500). In step 1500, the packet is still formatted for the WDB_RPC protocol (e.g., it is still a UDP packet). In certain embodiments, the software may receive the data packet at any point prior to its actually being sent over the expected medium. For example, software entity 180 may receive the outgoing packet from the handlers for the expected medium.

Software entity 180 then wraps the packet for transmission across the indirect connection 165 (Step 1505). In doing so, software entity 180 sizes the packet and places the size information in the wrapper. Software entity 180 then reads the memory spaces BFRLOC and BFRSIZ from the mailbox space 199 (Step 1510) and verifies that the packet to transmit will fit by comparing the size of the packet to the value in BFRSIZ (Step 1520). If the packet fits (Step 1520), software entity 180 writes the packet to BFRLOC (Step 1530). Otherwise, an error is generated (Step 1535). In certain embodiments, BFRLOC and BFRSIZ remain constant after an initial write and are read from only once.

Software entity 180 then writes the address of the packet to the memory space HTT_HS (Step 1540). In certain embodiments, the value written to HTT_HS can be the same as BFRLOC. In such an embodiment, if a value is written to HTT_HS other than the value in BFRLOC, an error is generated.

In certain embodiments a protection mechanism (e.g., a semaphore) can be used to control access to the mailbox space at wdbDtmPktDrvUp. This control may prevent both the target and the host from attempting to write to the same address within the mailbox space at the same time, which could lead to data loss.

FIG. 6 shows the method by which agent 160 retrieves the packet sent by server 150 from the mailbox space 199. Agent 160 polls the memory location HTT_HS of the mailbox until agent 160 sees a value other than 0x0 or 0xFFFFFFFF in the memory location (Step 1600) Preferably, agent 160 is using Wind River Systems' “direct to memory” packet driver (wdbDtmPktDrv) to poll. When agent 160 sees a value other than 0x0 or 0xFFFFFFFF in HTT_HS, agent 160 treats the value as an address. Agent 160 writes 0x0 to the HTT_HS address (Step 1605). Agent 160 then reads the front end of the wrapper for the packet from the address (Step 1610). Agent 160 decodes the wrapper (Step 1620). In so doing, agent 160 retrieves the size of the packet. When decoding the packet, the size information obtained in Step 1610 is used to determine where the packet and wrapper end. The agent 160 then reads the entire packet (Step 1630). When reading the packet, the size information obtained in step 1610 is used to determine where the packet ends.

Agent 160 then writes 0xFFFFFFFF back to the HTT_HS memory location of the mailbox (Step 1640), and uses the information contained in the decoded wrapper (from step 1620) to recreate the original packet (Step 1650).

Agent 160 then hands the original packet to a packet engine (e.g., a UDP packet engine that is implemented in the application 140) for execution (Step 1660).

In a embodiment utilizing parallel processing, steps 1630 and 1640 can be performed in parallel with Steps 1640 and 1650.

In certain embodiments, a protection mechanism (e.g., a semaphore) can be used to control access to the mailbox space at wdbDtmPktDrvUp. This control may prevent both the target and the host from attempting to write to the same address within the mailbox space at the same time, which could lead to data loss. For example, agent 160 may receive the semaphore before polling begins.

FIG. 7 shows the method by which agent 160 writes to the mailbox space 199. Agent 160 intercepts the outgoing packet from the application 140 or the target 110 itself (Step 700). Agent 160 then wraps the packet (Step 710) and writes the packet to the memory buffer 198 (Step 715). Agent 160 then puts the address of the memory buffer that contains the packet into the mailbox at the memory space TTH_HS (Step 720).

In certain embodiments, a protection mechanism (e.g., a semaphore) can be used to control access to the mailbox space at wdbDtmPktDrvUp. This control may prevent both the target and the host from attempting to write to the same address within the mailbox space at the same time, which could lead to data loss. For example, agent 160 may receive the semaphore before writing begins.

FIG. 8 shows the method by which server 150 retrieves the packets from the mailbox space 199. Software entity 180 polls the memory location TTH_HS of the mailbox until software entity 180 sees a value other than 0x0 or 0xFFFFFFFF (Step 800). When software entity 180 sees a value other than 0x0 or 0xFFFFFFFF, software entity 180 writes 0x0 to the memory location (Step 805). Software entity 180 treats the value read as an address and reads the front end of the wrapper for the packet from the address (Step 810). Software entity 180 then decodes the wrapper to retrieve the size of the packet (Step 820). Once the size of the packet is known, software entity 180 reads the entire packet (Step 830). Software entity 180 then writes 0xFFFFFFFF back to the TTH_HS memory location of the mailbox (Step 840) and uses the information contained in the decoded wrapper to recreate the original packet (Step 850). Software entity 180 then hands the original packet to server 150 (Step 860). Preferably, the packet is sent via a dedicated socket. Steps 830 and 840 can be conducted in parallel with Steps 850 and 860.

In certain embodiments, a protection mechanism (e.g., a semaphore) can be used to control access to the mailbox space at wdbDtmPktDrvUp. This control may prevent both the target and the host from attempting to write to the same address within the mailbox space at the same time, which could lead to data loss. For example, software entity 180 may receive the semaphore before polling begins.

In a parallel processing environment, the methods of FIGS. 5-8 can be implemented as separate threads or processes.

In the preceding specification, the invention has been described with reference to specific exemplary embodiments thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. A method for transmitting a data entity comprising the steps of:
intercepting a first data entity from a stream of processing, before the stream of processing sends the first data entity over a first medium, the first medium differing from a second medium;
adding one or more data elements to the first data entity to generate a second data entity, the data elements allowing the second data entity to be transferred over the second medium;
transmitting the second data entity over the second medium;
removing the data elements from the second data entity to generate the first data entity; and
inserting the first data entity into the stream of processing, after the stream of processing would have sent the first data entity over the first medium.

2. A method for transmitting a plurality of data entities comprising the steps of:
(a) intercepting a first of a plurality of data entities from a stream of processing, before the stream of processing sends the first data entity over a first medium, the first medium differing from a second medium;
(b) adding one or more data elements to the first data entity to generate a second data entity, the data elements allowing the first data entity to be transferred over the second medium;
(c) transmitting the second data entity over the second medium;
(d) removing the data elements to generate the first data entity;
(e) inserting the first data entity into the stream of processing, after the stream of processing would have sent the data entity over the first medium; and
(f) repeating steps (a-e) for each one of the plurality of remaining data entities.

3. A method for receiving a transmitted data entity comprising the steps of:
receiving a first data entity transmitted over a second medium, the second medium different from a first medium, the first data entity having been transformed from a second data entity by the addition of one or more data elements;
generating the second data entity by removing the data elements; and
inserting the second data entity into a stream of processing.

4. A method for transmitting a data entity comprising the steps of:
intercepting a data entity from a stream of processing, before the stream of processing sends the data entity over a first medium, the first medium differing from a second medium;
adding one or more data elements to format the data entity for the second medium; and
sending the data entity over the second medium.

5. A method for transmitting a plurality of data entities in parallel comprising the step of generating a plurality of threads, each thread executable on a separate processing device and further comprising the steps of:
intercepting a first data entity from a stream of processing, before the stream of processing sends the first data entity over a first medium, the first medium differing from a second medium;
adding one or more data elements to the first data entity to generate a second data entity, the data elements allowing the second data entity to be transferred over the second medium;
transmitting the second data entity over the second medium;
removing the data elements from the second data entity to generate the first data entity; and
inserting the first data entity into the stream of processing, after the stream of processing would have sent the first data entity over the first medium.

6. The method as recited in claim 1 further comprising prior to the intercepting step, the step of inserting, by a software tool, the data entity into the stream of processing.

7. The method as recited in claim 1 wherein a host agent performs the step of adding the data elements.

8. The method as recited in claim 1 wherein a target agent performs the removing step.

9. The method as recited in claim 1 wherein a target agent performs the removing and inserting steps.

10. The method as recited in claim 1 wherein a target server performs the adding step.

11. The method as recited in claim 1 wherein a target server performs the intercepting and adding steps.

12. The method as recited in claim 1 wherein the steps of removing and inserting are performed on an ARC processor.

13. The method as recited in claim 1 wherein the step of adding further comprises the step of wrapping the first data entity with the data elements; and wherein the step of removing further comprises unwrapping the data elements from the second data entity.

14. The method as recited in claim 1 wherein the step of transmitting further comprises the steps of:
writing to a mailbox;
and reading from the mailbox.

15. The method as recited in claim 1 wherein the step of intercepting further comprises removing the first data entity from a plurality of first handlers and the step of inserting further comprises giving the first data entity to a plurality of second handlers.

16. The method as recited in claim 1 wherein he step of intercepting and inserting is performed by a medium translation layer.

17. The method as recited in claim 2 further comprising prior to the intercepting step, the step of inserting by a software tool, the data entity into the stream of processing.

18. The method as recited in claim 2 wherein a host agent performs the adding step.

19. The method as recited in claim 2 wherein a target agent performs the removing step.

20. The method as recited in claim 2 wherein a target agent performs the removing and inserting steps.

21. The method as recited in claim 2 wherein a target server performs the adding step.

22. The method as recited in claim 2 wherein a target server performs the intercepting and adding steps.

23. The method as recited in claim 2 wherein the steps of removing and inserting are performed on an ARC processor.

24. The method as recited in claim 2 wherein the step of adding further comprises the step of wrapping the first data entity with the data elements; and wherein the step of removing further comprises unwrapping the data elements from the second data entity.

25. The method as recited in claim 2 wherein the step of transmitting further comprises the steps of:
writing to a mailbox;
and reading from the mailbox.

26. The method as recited in claim 2 wherein the step of intercepting further comprises removing the first data entity from a plurality of first handlers and the step of inserting further comprises giving the first data entity to a plurality of second handlers.

27. The method as recited in claim 2 wherein the steps of intercepting and inserting are performed by a medium translation layer.

28. The method as recited in claim 3 wherein a target agent performs the step of generating the second data entity.

29. The method as recited in claim 3 wherein the steps of receiving, generating, and inserting are performed on an ARC processor.

30. The method as recited in claim 3 wherein a target agent performs the generating step.

31. The method as recited in claim 3 wherein a target agent performs the generating and inserting steps.

32. The method as recited in claim 3 wherein the step of generating further comprises unwrapping the data elements from the second data entity.

33. The method as recited in claim 3 wherein the step of receiving further comprises the step of reading from a mailbox.

34. The method as recited in claim 4 further comprising prior to the step of intercepting, the step of inserting, by a software tool, the data entity into the stream of processing.

35. The method as recited in claim 4 wherein a host agent performs the adding step.

36. The method as recited in claim 4 wherein the step of adding farther comprises the step of wrapping the data entity with the data elements.

37. The method as recited in claim 4 wherein the step of sending further comprises writing to a mailbox.

38. The method as recited in claim 4 wherein the step of intercepting further comprises removing the data entity from a plurality of first handlers.

39. The method as recited in claim 4 wherein the step of intercepting is performed by a medium translation layer.

40. The method as recited in claim 4 wherein a target server performs the adding step.

41. The method as recited in claim 4 wherein a target server performs the intercepting and adding steps.

42. A system comprising:
a host, the host operable to:
intercept a first data entity from a stream of processing, before the stream of processing sends the data entity over a first medium;
add one or more data elements to generate a second data entity, the second data entity formatted for a second medium; and
send the second data entity over the second medium, the second medium different from the first medium;
a target, the target operable to:
receive the second data entity from the second medium;
generate the first data entity by removing the data elements; and
insert the first data entity into a stream of processing.

43. A host comprising:
a host computing environment, the host computing environment operable to:
intercept a first data entity from a stream of processing, before the stream of processing sends the data entity over a first medium;
add one or more data elements to generate a second data entity, the second data entity formatted for the second medium and the second medium different from the first medium; and
send the second data entity over the second medium.

44. A target comprising:
a target computing environment, the target computing environment operable to:
receive a first data entity transmitted over a second medium, the second medium different from a first medium, the first data entity having been transformed from a second data entity by the addition of one or more data elements;
generate the second data entity by removing the data elements; and
insert the second data entity into a stream of processing.

45. The system as recited in claim 42 wherein the host is a server; and wherein the target is a client.

46. The system as recited in claim 42 wherein the host computing environment further includes a debugger.

47. The system as recited in claim 42 wherein the target is a system development board.

48. The system as recited in claim 43 wherein the host is a server.

49. The system as recited in claim 43 wherein the host computing environment further includes a debugger.

50. The system as recited in claim 44 wherein the target is a client.

51. The system as recited in claim 44 wherein the target is a system development board.

52. The system as recited in claim 43 further comprising an output arranged to be coupled to a second medium.

53. The system as recited in claim 44 further comprising an output arranged to be coupled to a second medium.

54. A system comprising:
a second medium, the second medium different from a first medium;
a server, the server operable to:
intercept a first data entity from a stream of processing, before the stream of processing sends the data entity over the first medium;
add one or more data elements to generate a second data entity, the second data entity formatted for the second medium;
send the second data entity over the second medium, the second medium different from the first medium;
a client, the client operable to:
receive the second data entity from the second medium;
generate the first data entity by removing the data elements; and
insert the first data entity into a stream of processing.

55. A system comprising:
a second medium, the second medium different from a first medium;
a server, the server operable to:
intercept a first data entity from a stream of processing, before the stream of processing sends the data entity over the first medium;
add one or more data elements to generate a second data entity, the second data entity formatted for the second medium; and
send the second data entity over the second medium, the second medium different from the first medium and connecting a server to a client.

56. A system comprising:
a second medium, the second medium different from a first medium;
a client, the client operable to:
receive a second data entity from the second medium;
generate a first data entity by removing a plurality of data elements added to the data entity to format the data entity for the second medium; and
insert the first data entity into a stream of processing.

57. A system comprising:
a target server, the target server operable to:
intercept a first data entity from a stream of processing, before the stream of processing sends the data entity over a first medium;
add one or more data elements to generate a second data entity, the second data entity formatted for a second medium; and
send the second data entity over the second medium, the second medium different from the first medium;
a target agent, the target agent operable to:
receive the second data entity from the second medium;
generate the first data entity by removing the data elements; and
insert the first data entity into a stream of processing.

58. A target server comprising:
a target server computing environment, the target server computing environment operable to:
intercept a first data entity from a stream of processing, before the stream of processing sends the data entity over a first medium;
add one or more data elements to generate a second data entity, the second data entity formatted for the second medium and the second medium different from the first medium; and
send the second data entity over the second medium.

59. A target agent comprising:
a target agent computing environment, the target agent computing environment operable to:
receive a first data entity transmitted over a second medium, the second medium different from a first medium, the first data entity having been transformed from a second data entity by the addition of one or more data elements;
generate the second data entity by removing the data elements; and
insert the second data entity into a stream of processing.

60. A method for transmitting a data entity comprising the steps of:
intercepting a first data entity from a stream of processing, before the stream of processing sends the first data entity over a first medium, the first medium differing from a second medium;
adding one or more data elements to the first data entity to generate a second data entity, the data elements allowing the second data entity to be transferred over the second medium;
transmitting the second data entity over the second medium; and
inserting the second data entity into the stream of processing, after the stream of processing would have sent the first data entity over the first medium.

61. A method for transmitting a plurality of data entities comprising the steps of:
(a) intercepting a first of a plurality of data entities from a stream of processing, before the stream of processing sends the first data entity over a first medium, the first medium differing from a second medium;
(b) adding one or more data elements to the first data entity to generate a second data entity, the data elements allowing the first data entity to be transferred over the second medium;
(c) transmitting the second data entity over the second medium;
(d) inserting the second data entity into the stream of processing, after the stream of processing would have sent the data entity over the first medium; and
(e) repeating steps (a-d) for each one of the plurality of remaining data entities.

62. A method for transmitting a data entity comprising the steps of:
intercepting a first data entity from a stream of processing, before the stream of processing sends the first data entity over a first medium, the first medium differing from a second medium;
transmitting the first data entity over the second medium;
removing one or more data elements from the first data entity to generate a second data entity; and
inserting the second data entity into the stream of processing, after the stream of processing would have sent the first data entity over the first mediumn.

63. A method for transmitting a plurality of data entities comprising the steps of:
(a) intercepting a first of a plurality of data entities from a stream of processing, before the stream of processing sends the data entity over a first medium, the first medium differing from a second medium;
(b) transmitting the first data entity over the second medium;
(c) removing one or more data elements from the first data entity to generate a second data entity;
(d) inserting the second data entity into the stream of processing, after the stream of processing would have sent the data entity over the first medium; and
(e) repeating steps (a-d) for each one of the plurality of remaining data entities.

64. A method for transmitting a data entity comprising the steps of:
intercepting a first data entity from a stream of processing, before the stream of processing sends the first data entity over a first medium, the first medium differing from a second medium;
formatting the first data entity to generate a second data entity, the second data entity able to be transferred over the second medium;
transmitting the second data entity over the second medium;
formatting the second data entity to generate the first data entity; and
inserting the first data entity into the stream of processing, after the stream of processing would have sent the first data entity over the first medium.

65. A method for transmitting a plurality of data entities comprising the steps of:
(a) intercepting a first of a plurality of data entities from a stream of processing, before the stream of processing sends the first data entity over a first medium, the first medium differing from a second medium;
(b) formatting the first data entity to generate a second data entity, the second data entity able to be transferred over the second medium;
(c) transmitting the second data entity over the second medium;
(d) formatting the second data entity to generate the first data entity;
(e) inserting the first data entity into the stream of processing, after the stream of processing would have sent the data entity over the first medium; and
(f) repeating steps (a-e) for each one of the plurality of remaining data entities.

66. A method for receiving a transmitted data entity comprising the steps of:
receiving a first data entity transmitted over a second medium, the second medium different from a first medium, the first data entity having been formatted from a second data entity;
formatting the first data entity to generate the second data entity by removing the data elements; and
inserting the second data entity into a stream of processing.

67. A method for transmitting a data entity comprising the steps of:
intercepting a data entity from a stream of processing, before the stream of processing sends the data entity over a first medium, the first medium differing from a second medium;
formatting the data entity for the second medium; and
sending the data entity over the second medium.

68. A method for transmitting a plurality of data entities in parallel comprising the step of generating a plurality of threads, each thread executable on a separate processing device and further comprising the steps of:
intercepting a first data entity from a stream of processing, before the stream of processing sends the first data entity over a first medium, the first medium differing from a second medium;
formatting the first data entity to generate a second data entity, the second data entity able to be transferred over the second medium;
transmitting the second data entity over the second medium;
formatting the second data entity to generate the first data entity; and
inserting the first data entity into the stream of processing, after the stream of processing would have sent the first data entity over the first medium.

69. A system comprising
a software development tool;
a target server accessible by the software development tool to receive a data entity from the software development tool and configured to generate a first package based on the data entity and formatted for transmission over a first communication medium; and
a medium translation system coupled to the target server and configured to receive the first package,
convert the first package into a second package based on the first package and formatted for transmission over a second communication medium different from the first communication medium,
check availability of a buffer on a target,
send the second package over the second communication medium to the buffer when the buffer is available, and
send an indication to the target that the second package is present in the buffer.

70. The system as recited in claim 69, wherein the indication included the address of a memory location of the second package.

71. Computer readable media, having stored thereon, computer executable process steps operable to control a computer, the process steps comprising:
intercepting a first data entity from a stream of processing, before the stream of processing sends the first data entity over a first medium, the first medium differing from a second medium;
adding one or more data elements to the first data entity to generate a second data entity, the data elements allowing the second data entity to be transferred over the second medium;
transmitting the second data entity over the second medium;
removing the data elements from the second data entity to generate the first data entity; and
inserting the first data entity into the stream of processing, after the stream of processing would have sent the first data entity over the first medium.

72. Computer readable media, having stored thereon, computer executable process steps operable to control a computer, the process steps comprising:
(a) intercepting a first of a plurality of data entities from a stream of processing, before the stream of processing sends the first data entity over a first medium, the first medium differing from a second medium;
(b) adding one or more data elements to the first data entity to generate a second data entity, the data elements allowing the first data entity to be transferred over the second medium;
(c) transmitting the second data entity over the second medium;
(d) removing the data elements to generate the first data entity;
(e) inserting the first data entity into the stream of processing, after the stream of processing would have sent the data entity over the first medium; and
(f) repeating steps (a-e) for each one of the plurality of remaining data entities.

73. Computer readable media, having stored thereon, computer executable process steps operable to control a computer, the process steps comprising:
receiving a first data entity transmitted over a second medium, the second medium different from a first medium, the first data entity having been transformed from a second data entity by the addition of one or more data elements;
generating the second data entity by removing the data elements; and
inserting the second data entity into a stream of processing.

74. Computer readable media, having stored thereon, computer executable process steps operable to control a computer, the process steps comprising:
intercepting a data entity from a stream of processing, before the stream of processing sends the data entity over a first medium, the first medium differing from a second medium;
adding one or more data elements to format the data entity for the second medium; and
sending the data entity over the second medium.

75. Computer readable media, having stored thereon, computer executable process steps operable to control a computer to transmit a plurality of data entities in parallel, the process steps comprising generating a plurality of threads, each thread executable on a separate processing device and further comprising the steps of:
intercepting a first data entity from a stream of processing, before the stream of processing sends the first data entity over a first medium, the first medium differing from a second medium;
adding one or more data elements to the first data entity to generate a second data entity, the data elements allowing the second data entity to be transferred over the second medium;
transmitting the second data entity over the second medium;
removing the data elements from the second data entity to generate the first data entity; and
inserting the first data entity into the stream of processing, after the stream of processing would have sent the first data entity over the first medium.
